(19) United States
(12) Patent Application Publication
(10) Pub. No.: US 2026/0147448 A1
(43) Pub. Date: May 28, 2026

(54) INFORMATION DISPLAY METHOD, ELECTRONIC DEVICE, AND STORAGE MEDIUM

(71) Applicant: Douyin Vision Co., Ltd., Beijing (CN)

(72) Inventors: Chuanqi JING, Beijing (CN); Jinghua Li, Beijing (CN); Wenchao Wang, Beijing (CN); Xingwen Zhang, Beijing (CN)

(21) Appl. No.: 19/310,837

(22) Filed: Aug. 26, 2025

(30) Foreign Application Priority Data
Nov. 28, 2024 (CN) 202411730613.0

(51) Int. Cl. G06F 3/0483; G06F 3/0482

(52) U.S. Cl. CPC G06F 3/0483; G06F 3/0482

(57) ABSTRACT

The present disclosure provides an information display method, an electronic device, and a storage medium. The method includes: displaying at least one column of information flow in a first page, and displaying first recommendation content in the information flow, wherein the first recommendation content is generated based on first published content, the first published content includes a first post belonging to a first topic and/or a first comment related to a first electronic book, and the first topic is related to the first electronic book; and displaying a second page in response to a trigger operation for the first recommendation content, wherein the second page includes a first display area and a second display area, the first display area is configured to display an image related to the first electronic book, and the second display area is configured to display at least the first published content.

### CROSS-REFERENCE TO RELATED APPLICATION

This application claims the priority to and benefits of the Chinese Patent Application, No. 202411730613.0, which was filed on Nov. 28, 2024. The aforementioned patent application is hereby incorporated by reference in its entirety.

### TECHNICAL FIELD

The present disclosure relates to the field of computer technology, and in particular, to an information display method, an electronic device, and storage medium.

### BACKGROUND

At present, users may read electronic books through reading applications. Thanks to the rapid development of database technology, thousands of electronic books of various categories may be collected in the reading applications, so as to meet the needs of different users for reading books of different categories. Based on this, how to recommend electronic books to users in reading applications and improve the efficiency of e-book recommendation has become one of the urgent problems to be solved.

### SUMMARY

Embodiments of the present disclosure provide an information display method, an apparatus, and a related product, which may improve the efficiency of e-book recommendation.

An embodiment of the present disclosure provides an information display method, comprising:
displaying at least one column of information flow in a first page, and displaying first recommendation content in the information flow, wherein the first recommendation content is generated based on first published content, the first published content comprises a first post belonging to at least one selected from a group of a first topic or a first comment related to a first electronic book, and the first topic is related to the first electronic book; and
displaying a second page in response to a trigger operation for the first recommendation content, wherein the second page comprises a first display area and a second display area, the first display area is configured to display an image related to the first electronic book, and the second display area is configured to display at least the first published content.

An embodiment of the present disclosure provides an information display apparatus, comprising:
a first display unit, configured to display at least one column of information flow in a first page, and display first recommendation content in the information flow, wherein the first recommendation content is generated based on first published content, the first published content comprises a first post belonging to at least one selected from a group of a first topic or a first comment related to a first electronic book, and the first topic is related to the first electronic book; and
a second display unit, configured to display a second page in response to a trigger operation for the first recommendation content, wherein the second page comprises a first display area and a second display area, the first display area is configured to display an image related to the first electronic book, and the second display area is configured to display at least the first published content.

An embodiment of the present disclosure provides an electronic device, comprising: a processor; and a memory configured to store computer-executable instructions, where the computer-executable instructions, when executed, cause the processor to implement the method according to the foregoing first aspect.

An embodiment of the present disclosure provides a computer-readable storage medium, configured to store computer-executable instructions, where the computer-executable instructions, when executed by a processor, implement the method according to the foregoing first aspect.

An embodiment of the present disclosure provides a computer program product, comprising a computer program, where the computer program, when executed by at least a processor, implements the method according to the foregoing first aspect.

### BRIEF DESCRIPTION OF DRAWINGS

In order to more clearly illustrate the technical solutions in one or more embodiments of the present disclosure or in the prior art, the following will briefly introduce the drawings that need to be used in the description of the embodiments or the prior art. Obviously, the drawings in the following description are only some embodiments recorded in the present disclosure. For those of ordinary skill in the art, other drawings may be obtained based on these drawings without creative efforts.

FIG. 1 is a schematic flowchart of an information display method according to an embodiment of the present disclosure.

FIG. 2a is a schematic diagram of first recommendation content according to an embodiment of the present disclosure.

FIG. 2b is a schematic diagram of first recommendation content according to another embodiment of the present disclosure.

FIG. 3a is a schematic diagram of a second page according to an embodiment of the present disclosure.

FIG. 3b is a schematic diagram of a second page according to another embodiment of the present disclosure.

FIG. 4a is a schematic diagram of a book list logo according to an embodiment of the present disclosure.

FIG. 4b is a schematic diagram of a book list according to an embodiment of the present disclosure.

FIG. 5 is a schematic structural diagram of an information display apparatus according to an embodiment of the present disclosure.

FIG. 6 is a schematic structural diagram of an electronic device according to an embodiment of the present disclosure.

### DETAILED DESCRIPTION

In order for persons skilled in the art to better understand the technical solutions in one or more embodiments of the present disclosure, the technical solutions in one or more embodiments of the present disclosure will be described below clearly and comprehensively with reference to the drawings in one or more embodiments of the present disclosure. Obviously, the described embodiments are merely some rather than all of the embodiments of the present disclosure. All other embodiments obtained by persons of ordinary skill in the art based on one or more embodiments of the present disclosure without creative efforts shall fall within the scope of protection of the present disclosure.

It may be understood that before the use of the technical solutions disclosed in the embodiments of the present disclosure, the user shall be informed of the type, range of use, use scenarios, etc., of personal information involved in the present disclosure in an appropriate manner and the authorization of the user shall be obtained in accordance with relevant laws and regulations.

For example, in response to reception of an active request from a user, prompt information is sent to the user to clearly inform the user that the requested operation will require access to and use of personal information of the user. In this way, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may also comprise a selection control for the user to choose whether to “agree” or “disagree” to provide the personal information to the electronic device.

It may be understood that the above process of notifying and obtaining user authorization is only illustrative and does not constitute a limitation on the implementations of the present disclosure, and other manners that satisfy the relevant laws and regulations may also be applied in the implementations of the present disclosure.

An embodiment of the present disclosure provides an information display method. For the scenario of reading an electronic book through a reading application, the efficiency of e-book recommendation may be improved by the information display method in the present embodiment. The information display method may be applied to a terminal device, and executed by the terminal device. The terminal device comprises, but is not limited to, an electronic product, such as a mobile phone, a computer, a tablet computer, a laptop computer, a desktop computer, a vehicle-mounted computer, a wearable device, an Internet of Things device, and a vehicle networking device.

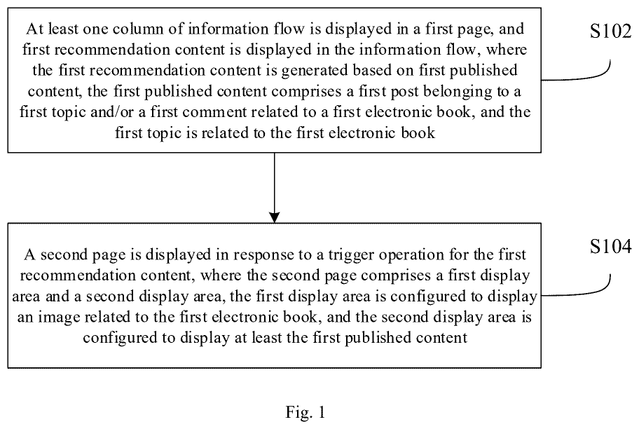

FIG. 1 is a schematic flowchart of an information display method according to an embodiment of the present disclosure. As shown in FIG. 1, the process comprises steps S102 and S104.

In step S102, at least one column of information flow is displayed in a first page, and first recommendation content is displayed in the information flow, where the first recommendation content is generated based on first published content, the first published content comprises a first post belonging to a first topic and/or a first comment related to a first electronic book, and the first topic is related to the first electronic book.

In step S104, a second page is displayed in response to a trigger operation for the first recommendation content, where the second page comprises a first display area and a second display area, the first display area is configured to display an image related to the first electronic book, and the second display area is configured to display at least the first published content.

In one or more embodiments of the present disclosure, first, at least one column of information flow is displayed in a first page, and first recommendation content is displayed in the information flow, where the first recommendation content is generated based on first published content, the first published content comprises a first post belonging to a first topic and/or a first comment related to a first electronic book, and the first topic is related to the first electronic book; then, a second page is displayed in response to a trigger operation for the first recommendation content, where the second page comprises a first display area and a second display area, the first display area is configured to display an image related to the first electronic book, and the second display area is configured to display at least the first published content. It may be seen that according to the present embodiment, the first recommendation content may be displayed in the at least one column of information flow, and the image related to the first electronic book and the first published content are displayed when the first recommendation content is triggered. It may be understood that the first published content is related to the first electronic book, and since the first recommendation content is generated based on the first published content, the first recommendation content is also related to the first electronic book. Therefore, according to the present embodiment, the effect of recommending the first electronic book to the user may be achieved based on the first recommendation content, the image related to the first electronic book, and the first published content, thereby improving the efficiency of recommending the electronic book to the user.

In the foregoing step S102, the first page may be a page in a reading application. In an example, the first page is a home page of the reading application. In the present embodiment, the reading application is an application running on a terminal device for the user to read electronic books. In the reading application, the user may also listen to audio data of an electronic book.

In the foregoing step S102, one or more columns of information flow are displayed in the first page. For example, the first page is divided into left and right half screens, a column of information flow is displayed in the left half screen, and a column of information flow is displayed in the right half screen, so that two columns of information flow are displayed in the first page. Certainly, the first page may also be divided into left, middle, and right three-part screens, and a column of information flow is displayed in each part of the screen, so that three columns of information flow are displayed.

In the foregoing step S102, the first recommendation content is displayed in any column of information flow. The first recommendation content is generated based on the first published content published by the user to the reading application. The first published content comprises the first post and/or the first comment.

The first comment may be a comment related to the first electronic book. For example, the first comment is the user's comment on a wonderful plot in the first electronic book, the user publishes the first comment to the reading application, and the first published content comprises the first comment.

In the present embodiment, there are a plurality of topics in the reading application, and the user may publish the first post under a first topic among the plurality of topics, and therefore, the first post belongs to the first topic. In addition, the first post is related to the first electronic book, and the first topic is also related to the first electronic book, that is, the first post, the first topic, and the first electronic book are related to each other. Specifically, in one case, in the case where the first post is related to the first electronic book, the first topic is also related to the first electronic book. For example, if the first electronic book is mentioned in the first post, it is determined that the first post is related to the first electronic book, and since the first post belongs to the first topic, it is determined that the first topic is also related to the first electronic book. In another case, in the case where the first topic is related to the first electronic book, the first post is also related to the first electronic book. For example, if the first electronic book is mentioned in the first topic, it is determined that the first topic is related to the first electronic book, and since the first post belongs to the first topic, it is determined that the first post is also related to the first electronic book.

The relationship between the first electronic book, the first comment, the first topic, and the first post in the present embodiment may be understood as follows. The user may publish the first comment for the first electronic book, and therefore, the first electronic book and the first comment are related to each other. The user may publish the first post under the first topic, and therefore, the first topic and the first post are correlated with each other. In one case, if the content of the first post is related to the first electronic book, the first electronic book, the first post, and the first topic are also related to one another. In another case, if the topic name of the first topic is related to the first electronic book, the first electronic book, the first post, and the first topic are also related to one another.

In the present embodiment, the first recommendation content is generated based on the first published content, that is, based on at least one selected from a group of the first post or the first comment. In an embodiment, the first recommendation content comprises an image part and a text part, the image part comprises an image related to the first electronic book, and the text part comprises content description information of the first published content and user description information of a user who publishes the first published content.

In the present embodiment, the first recommendation content is set to comprise the image part and the text part, where the image part of the first recommendation content comprises the image related to the first electronic book, so as to indicate that the first recommendation content is the recommendation content related to the first electronic book. The image related to the first electronic book comprises, but is not limited to, at least one selected from the group of a cover picture, an illustration, and a character picture of the first electronic book.

The text part of the first recommendation content comprises the content description information of the first published content and the user description information of the user who publishes the first published content. The content description information is configured to represent basic information of the first published content. For example, if the first published content comprises the first comment, the content description information may comprise part of the original text of the first comment. For another example, if the first published content comprises the first post, the content description information may comprise part of the original text of the first post. The user description information is configured to describe basic information of the user who publishes the first published content, for example, the user description information comprises a user identifier.

It may be seen that according to the present embodiment, the first recommendation content may be represented in the at least one piece of information flow in a manner of combining an image with text, thereby improving the efficiency of recommending the first electronic book through the first recommendation content.

In an embodiment, the content description information of the first published content comprises at least one selected from the group of a content summary of the first published content, original published information of the first published content, or electronic book information of the first electronic book, and the user description information comprises at least one selected from the group of a user identifier, a user social relationship, or information on an association degree between the user and the first electronic book.

In the present embodiment, the content description information of the first published content comprises at least one selected from the group of a content summary of the first published content, original published information of the first published content, or electronic book information of the first electronic book. The content summary of the first published content may be part of the original text of the first published content, or may be a summary of the content in the first published content. When the first published content comprises the first post, the original published information of the first published content may be used to represent a topic identifier of the first topic to which the first post belongs. When the first published content comprises the first comment, the original published information of the first published content may represent a specific chapter or plot of the first electronic book for which the first comment is made. The electronic book information of the first electronic book comprises, but is not limited to, information such as the book name of the first electronic book.

In the present embodiment, the user description information of the user who publishes the first published content comprises at least one selected from the group of a user identifier, a user social relationship, or information on an association degree between the user and the first electronic book. The user identifier comprises at least one selected from the group of a user avatar or a user name. The user social relationship is used to represent the relationship between the user who publishes the first published content and the current browsing user. For example, the user who publishes the first published content and the current browsing user are friends who follow each other, or the user who publishes the first published content is followed by the current browsing user, etc. The information on the association degree between the user and the first electronic book is used to represent the magnitude of the association degree between the user who publishes the first published content and the first electronic book. For example, if the first published content comprises the first comment and/or the first post published by the user after browsing the first electronic book for a certain period of time, the information on the association degree may comprise the browsing duration. The information on the association degree may also comprise evaluation information of the user who publishes the first published content on the first electronic book.

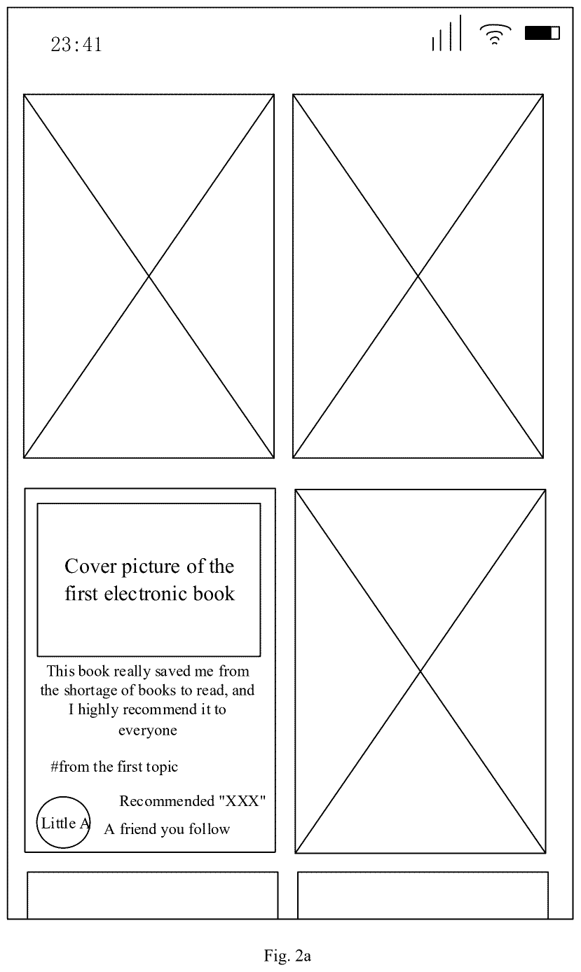

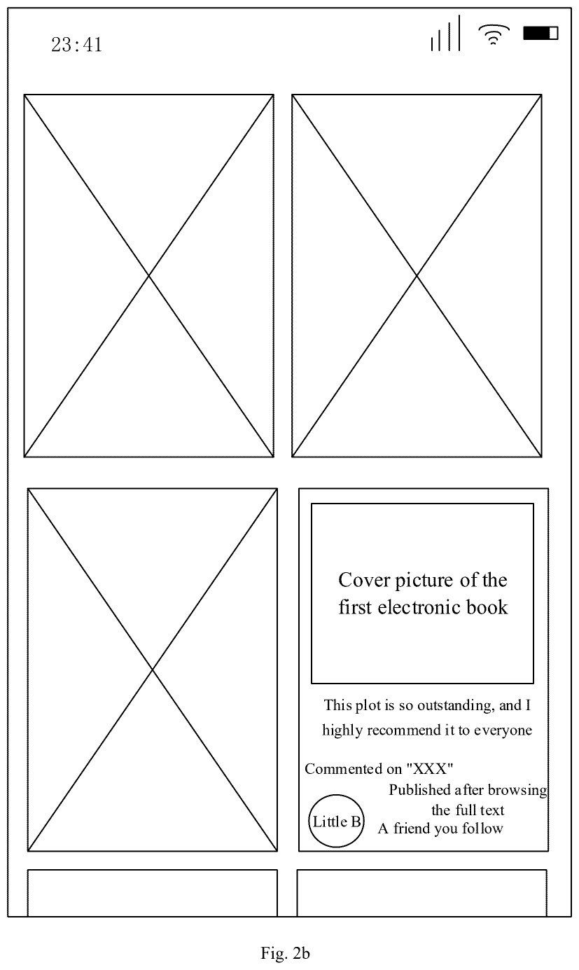

FIG. 2a is a schematic diagram of first recommendation content according to an embodiment of the present disclosure. As shown in FIG. 2a, two columns of information flow are displayed in the first page, the first recommendation content is displayed in one column of information flow, and the first recommendation content is generated based on the first post. The first recommendation content comprises an image part, and the image part comprises an image related to the first electronic book. In FIG. 2a, the cover picture of the first electronic book is used as an example for illustration, and the image related to the first electronic book may also be provided by the user who publishes the first post.

In FIG. 2a, the first recommendation content further comprises a text part, and the text part comprises the foregoing content description information and user description information. The content description information comprises part of the original text of the first post, such as “This book really saved me from the shortage of books to read, and I highly recommend it to everyone”, and the content description information also comprises a topic identifier of the first topic to which the first post belongs, such as “from the first topic”, and the content description information also comprises name information of the first electronic book, such as “recommended “XXX””, where XXX is the book name of the first electronic book. The user description information comprises a user avatar, a user name “Little A”, and a user social relationship, such as “a friend you follow”, indicating that the first post is published by a friend followed by the current browsing user.

FIG. 2b is a schematic diagram of first recommendation content according to another embodiment of the present disclosure. As shown in FIG. 2b, two columns of information flow are displayed in the first page, the first recommendation content is displayed in one column of information flow, and the first recommendation content is generated based on the first comment. The first recommendation content comprises an image part, and the image part comprises an image related to the first electronic book. In FIG. 2b, the cover picture of the first electronic book is used as an example for illustration, and the image related to the first electronic book may also be provided by the user who publishes the first comment.

In FIG. 2b, the first recommendation content further comprises a text part, and the text part comprises the foregoing content description information and user description information. The content description information comprises part of the original text of the first comment, such as “This plot is so outstanding, and I highly recommend it to everyone”, and the content description information also comprises name information of the first electronic book, such as “commented on “XXX””, where XXX is the book name of the first electronic book. The user description information comprises a user avatar, a user name “Little B”, a user social relationship, such as “a friend you follow”, and information on an association degree between the user and the first electronic book, such as “published after browsing the full text”. The user social relationship indicates that the first comment is published by a friend followed by the current browsing user, and the information on the association degree between the user and the first electronic book indicates that the user who publishes the first comment publishes the first comment after browsing the full text of the first electronic book.

It may be seen that according to the present embodiment, the content description information of the first published content and the user description information of the user who publishes the first published content may be reflected in the first recommendation content, and the efficiency of recommending the first electronic book through the first recommendation content may be improved through the content description information and the user description information.

In the foregoing step S104, the second page is displayed in response to the user's trigger operation for the first recommendation content, for example, a trigger operation for the image part or the text part of the first recommendation content. The second page comprises a first display area and a second display area, the first display area is configured to display an image related to the first electronic book, and the second display area is configured to display at least the first published content.

In the present embodiment, after the user triggers any part of the first recommendation content, the terminal device displays the second page in response to the trigger operation, and the second page has a first display area and a second display area. The image related to the first electronic book is displayed in the first display area, and the image may be the image displayed in the first recommendation content, or may be other images related to the first electronic book. The second display area is configured to display at least the first published content, for example, to display the first post and/or the first comment.

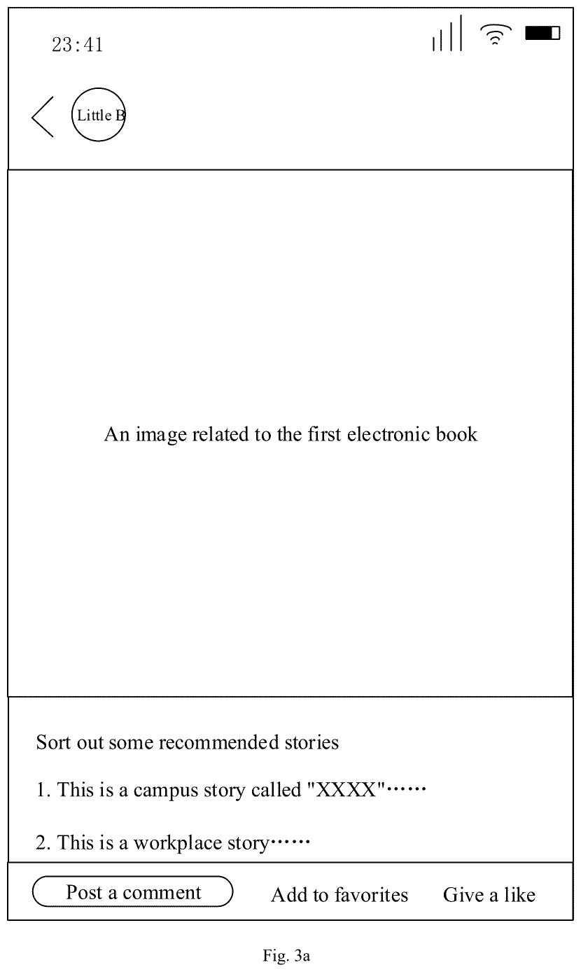

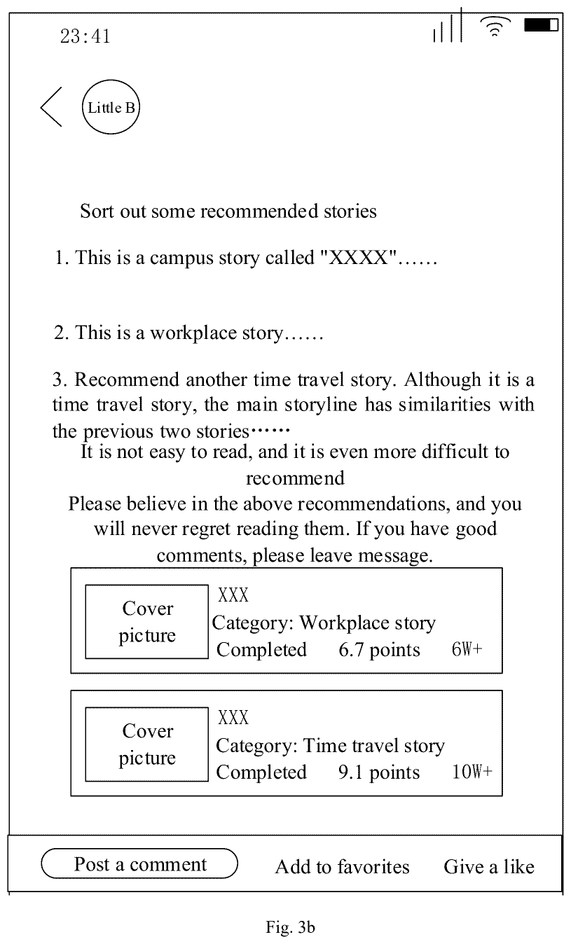

FIG. 3a is a schematic diagram of a second page according to an embodiment of the present disclosure, and FIG. 3b is a schematic diagram of a second page according to another embodiment of the present disclosure. FIG. 3b may be obtained by performing a swipe screen operation on FIG. 3a, for example, an operation of swiping up the screen. As shown in FIGS. 3a and 3b, the second page has a first display area, and the image related to the first electronic book is displayed in the first display area, for example, the image displayed in the first recommendation content is displayed. The second page also has a second display area, and the second display area is configured to display the first published content, so that the user may read the complete first published content.

It may be seen that according to the present embodiment, the first recommendation content may be displayed in the at least one column of information flow, and the second page is displayed when the first recommendation content is triggered, and the image related to the first electronic book and the first published content are displayed through the second page, thereby achieving the effect of recommending the first electronic book to the user based on the first recommendation content, the image related to the first electronic book, and the first published content, and improving the efficiency of recommending the electronic book to the user.

In an embodiment, the number of the first electronic book is one, and the method in the present embodiment further comprises:
determining hot spot information in the first electronic book, where the hot spot information comprises hot spot character information and/or hot spot plot information;
selecting the first comment from comments related to the hot spot information; and
determining a topic related to the hot spot information as the first topic, and selecting the first post from posts belonging to the first topic.

In the present embodiment, before the first recommendation content is delivered in the first page, it is also necessary to determine the first electronic book, the first topic, the first comment, and the first post, so as to generate the first recommendation content according to the first post and/or the first comment. Based on this, in the present embodiment, an electronic book that needs to be recommended emphatically may be used as the first electronic book, and the first topic, the first comment, and the first post are determined based on the first electronic book.

In the present embodiment, first, the hot spot information in the first electronic book is determined, the hot spot information refers to information that is liked and concerned by the user, and the hot spot information comprises at least one selected from the group of the hot spot character information or the hot spot plot information in the first electronic book. In an example, according to discussion information of users who read the first electronic book on the first electronic book, plot information in the first electronic book that is discussed more times by the users is determined as the hot spot plot information, and according to the discussion information of the users who read the first electronic book on the first electronic book, character information in the first electronic book that is discussed more times by the users is determined as the hot spot character information. The foregoing discussion information comprises any form of discussion information, such as comment information or a post, published by the users for the first electronic book. Furthermore, the hot spot plot information is used as the hot spot information of the first electronic book, or the hot spot character information is used as the hot spot information of the first electronic book, or the hot spot plot information and the hot spot character information are used as the hot spot information of the first electronic book.

Then, for the first electronic book, comments related to the foregoing hot spot information and published by the users who read the first electronic book are acquired, and one or more comments are selected from the comments as the first comment. In an example, the selected first comment satisfies at least one of the following requirements: the number of words in the first comment is greater than a certain number of words, the number of likes given to the first comment is greater than a certain number, the number of replies to the first comment is greater than a certain number of times, the user has read the first electronic book for more than a certain period of time when publishing the first comment, and the first comment does not comprise specified content.

Then, one or more topics related to the hot spot information of the first electronic book are determined as the first topic from topics existing in the reading application. The first topic is related to the hot spot information, which may be that the topic name of the first topic is related to the hot spot information of the first electronic book, or may be that the content of more than a certain number proportion of posts under the first topic is related to the hot spot information of the first electronic book. Then, for each first topic, one or more posts are selected from the posts under the first topic as the first post, so as to obtain one or more first posts based on each first topic. The post content of the first post is related to the hot spot information of the first electronic book. In an example, the first post satisfies at least one of the following requirements: the number of words in the first post is greater than a certain number of words, the number of likes given to the first post is greater than a certain number, the number of replies to the first post is greater than a certain number of times, the user has read the first electronic book for more than a certain period of time when publishing the first post, and the first post does not comprise specified content.

It may be seen that according to the present embodiment, in the case where the first electronic book is one, based on the hot spot information in the first electronic book, the comment related to the hot spot information may be selected as the first comment, and the post under the first topic related to the hot spot information may be selected as the first post, so that the first post is also related to the hot spot information, thereby generating the first published content through the first post and/or the first comment, and improving the efficiency of recommending the first electronic book to the user based on the first published content.

In an embodiment, there are a plurality of first electronic books, a value of a probability degree at which the first electronic books are recommended synchronously is greater than a degree threshold, and the method further comprises:
determining hot spot information in the first electronic books, where the hot spot information comprises hot spot character information and/or hot spot plot information;
selecting, for each of the first electronic books, the first comment of the first electronic book from comments related to the hot spot information of the first electronic book; and
determining a topic related to the first electronic books as the first topic, and selecting at least one first post from posts belonging to the first topic, where a content set of the first posts is used to introduce the first electronic books.

In the present embodiment, before the first recommendation content is delivered in the first page, it is also necessary to determine the first electronic book, the first topic, the first comment, and the first post, so as to generate the first recommendation content according to the first post and/or the first comment. Based on this, in the present embodiment, the plurality of electronic books whose value of the probability degree of being recommended synchronously is greater than the degree threshold may be used as the first electronic books respectively, so as to obtain the plurality of first electronic books, and the first topic, the first comment, and the first post are determined based on each of the first electronic books.

The value of the probability degree of being recommended synchronously is used to represent a probability degree at which the first electronic books are recommended synchronously to the user. For example, according to the author and category information of each electronic book, the value of the probability degree at which the electronic books are recommended synchronously to the user is determined. If the electronic books belong to the same author, the value of the probability degree at which the electronic books are recommended synchronously to the user is greater than the degree threshold. If the electronic books belong to the same category, the value of the probability degree at which the electronic books are recommended synchronously to the user is greater than the degree threshold. In the present embodiment, a plurality of electronic books belonging to the same author may be used as the first electronic books, or a plurality of electronic books belonging to the same category may be used as the first electronic books, or a plurality of electronic books belonging to the same publisher may be used as the first electronic books, or a plurality of electronic books belonging to the same book list may be used as the first electronic books, or a plurality of electronic books belonging to the same topic may be used as the first electronic books. The book list refers to a book list created by the reading application, which is used to introduce electronic books to the user.

In the present embodiment, first, the hot spot information in each first electronic book is determined, the hot spot information refers to information that is liked and concerned by the user, and the hot spot information comprises at least one selected from the group of the hot spot character information or the hot spot plot information in the first electronic book. In an example, for each first electronic book, according to discussion information of users who read the first electronic book on the first electronic book, plot information in the first electronic book that is discussed more times by the users is determined as the hot spot plot information, and according to the discussion information of the users who read the first electronic book on the first electronic book, character information in the first electronic book that is discussed more times by the users is determined as the hot spot character information. The foregoing discussion information comprises any form of discussion information, such as comment information or a post, published by the users for the first electronic book. Furthermore, the hot spot plot information is used as the hot spot information of the first electronic book, or the hot spot character information is used as the hot spot information of the first electronic book, or the hot spot plot information and the hot spot character information are used as the hot spot information of the first electronic book.

Then, for each first electronic book, comments related to the hot spot information of the first electronic book and published by the users who read the first electronic book are acquired, and one or more comments are selected from the comments as the first comment of the first electronic book, so as to obtain the first comment belonging to each first electronic book. In an example, the selected first comment satisfies at least one of the following requirements: the number of words in the first comment is greater than a certain number of words, the number of likes given to the first comment is greater than a certain number, the number of replies to the first comment is greater than a certain number of times, the user has read the first electronic book for more than a certain period of time when publishing the first comment, and the first comment does not comprise specified content.

Then, one or more topics related to the first electronic books are determined as the first topic from topics existing in the reading application. In the case where there are a plurality of first electronic books, a plurality of first topics may be determined, each first topic is related to at least one first electronic book, and the first topics are related to the first electronic books when being combined. The first topic is related to the first electronic books, which may be that the topic name of the first topic is related to the first electronic books, or may be that the content of more than a certain number proportion of posts under the first topic is related to the first electronic books. Then, for each first topic, one or more posts are selected from the posts under the first topic as the first post, so as to obtain one or more first posts based on each first topic. One first post may be used to introduce at least one first electronic book, and the content set of all selected first posts is used to introduce all first electronic books. That is, after a plurality of first posts are selected for the plurality of first electronic books, the content set of the a plurality of first posts may be used to introduce all first electronic books, so that the user may get knowledge of all first electronic books by reading all first posts. The post content of the first post is related to the first electronic book, and the first post may be used to recommend or introduce the first electronic book. In an example, the first post satisfies at least one of the following requirements: the number of words in the first post is greater than a certain number of words, the number of likes given to the first post is greater than a certain number, the number of replies to the first post is greater than a certain number of times, the user has read the first electronic book for more than a certain period of time when publishing the first post, and the first post does not comprise specified content.

It may be seen that according to the present embodiment, in the case where there are a plurality of first electronic books, based on the hot spot information in the first electronic books, the comment related to the hot spot information may be selected as the first comment, and the topic related to the first electronic books is determined as the first topic, and at least one first post is selected from the posts belonging to the first topic, and the content set of the first posts is used to introduce the first electronic books, thereby achieving the effect of introducing all first electronic books to the user through the first posts, and improving the efficiency of recommending the first electronic books to the user based on the first published content.

In an embodiment, the second display area in the second page is also configured to display first book information of the first electronic book, the first book information comprises first sub information embedded in the first published content, and/or second sub information located outside the first published content, and the method further comprises:
displaying a recommendation page of the first electronic book in response to a trigger operation for the first book information, or in response to a trigger operation for the image in the first display area.

In the present embodiment, after the second page is displayed, the second display area in the second page is also configured to display the first book information of the first electronic book. The number of the first electronic book may be one or more. The first book information of the first electronic book may be the first sub information embedded in the first published content, or may be the second sub information located outside the first published content. The first sub information comprises the book name of the first electronic book, and the second sub information comprises a book card of the first electronic book.

For example, the first published content comprises the book name of the first electronic book, and the first sub information comprises the book name. For another example, the book card of the first electronic book is provided behind the first published content in the second display area, and the second sub information comprises the book card. The cover picture, the book name, the book category, the serialization completion status, the number of readers, and the evaluation score of the first electronic book are displayed in the book card. A reading entry of the first electronic book may also be displayed in the book card.

As shown in FIG. 3a, the first sub information comprises the book name of the first electronic book in the first published content, and the first sub information may be highlighted by adding an underline. As shown in FIG. 3b, the book card of the first electronic book is provided behind the first published content in the second display area, and the second sub information of the first electronic book comprises the book card.

In one case, the first book information comprises the foregoing first sub information. In another case, the first book information comprises the foregoing second sub information. In still another case, the first book information comprises the foregoing first sub information and the foregoing second sub information.

In the present embodiment, the user may trigger the first book information, for example, the first sub information or the second sub information, and the user may also trigger the image related to the first electronic book displayed in the first display area in the second page. In response to any trigger operation, the terminal device displays the recommendation page of the first electronic book, and the first electronic book is recommended to the user through the recommendation page of the first electronic book.

It may be seen that according to the present embodiment, while browsing the second page, the user may also trigger the first sub information, the second sub information, or the image related to the first electronic book, and enter the recommendation page of the first electronic book based on the trigger operation, so that the first electronic book is recommended to the user by using the recommendation page of the first electronic book, thereby improving the recommendation efficiency.

In an embodiment, the method further comprises steps described below:
displaying a book list logo in the second page.
displaying a book list in response to a trigger operation for the book list logo, second book information of the first electronic book being displayed in the book list.
displaying a recommendation page of the first electronic book in response to a trigger operation for the second book information.

In the present embodiment, after the second page is displayed, the book list logo is also displayed in the second page, and the user may trigger the book list logo. In response to the user's trigger operation, the book list is displayed, and the second book information of the first electronic book is displayed in the book list. The number of the first electronic book may be one or more. The second book information of each first electronic book comprises a book card of the first electronic book, and the cover picture, the book name, the book category, the serialization completion status, the number of readers, and the evaluation score of the first electronic book are displayed in the book card.

The user may trigger the second book information, and in response to the trigger operation, the terminal device displays the recommendation page of the first electronic book, and the first electronic book is recommended to the user through the recommendation page of the first electronic book.

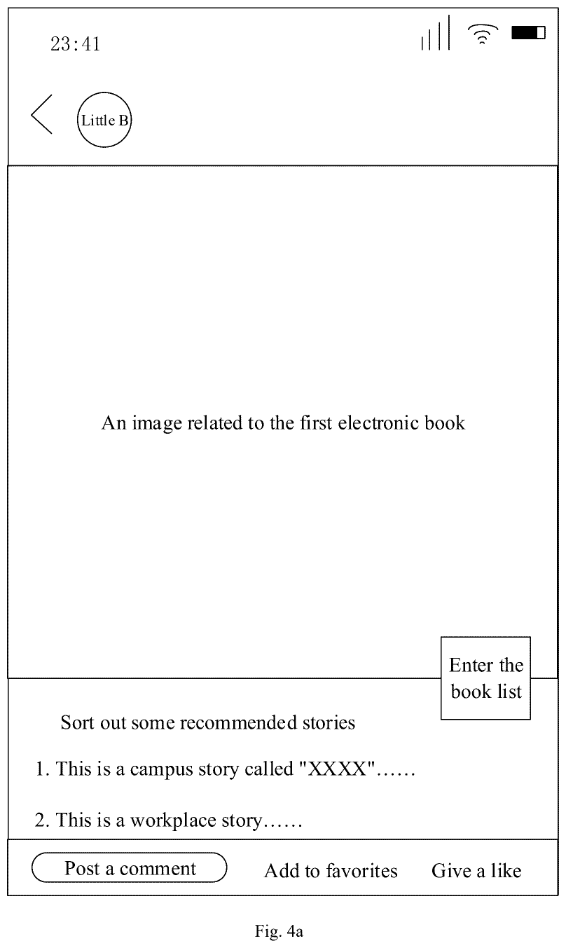

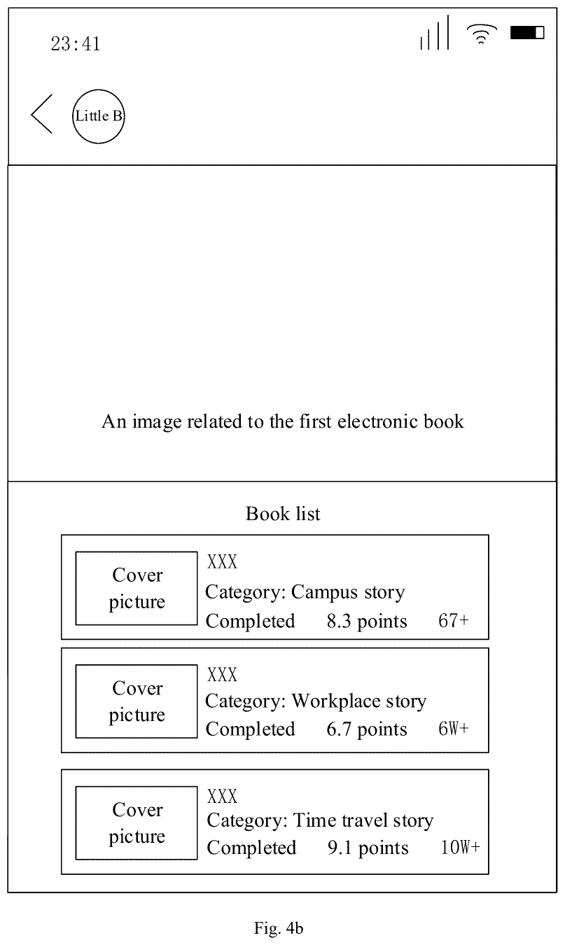

FIG. 4a is a schematic diagram of a book list logo according to an embodiment of the present disclosure, and FIG. 4b is a schematic diagram of a book list according to an embodiment of the present disclosure. As shown in FIG. 4a, in the case where there are a plurality of first electronic books, the book list logo may be displayed in the second page, and the book list logo may be a movable floating logo. If the user triggers the book list logo, as shown in FIG. 4b, the book list of each of the first electronic books may be displayed, and the second book information, such as the book card, of each first electronic book is displayed in the book list. If the user triggers the book card of any first electronic book, the terminal device displays the recommendation page of the triggered first electronic book, and the first electronic book is recommended to the user through the recommendation page of the first electronic book.

It may be seen that according to the present embodiment, the book list logo may also be displayed in the second page, the book list is displayed in response to the trigger operation for the book list logo, the second book information of the first electronic book is displayed in the book list, and the recommendation page of the first electronic book is displayed in response to the trigger operation for the second book information. Thus, in the case where there are a plurality of first electronic books, the user may be provided with the book list of the first electronic books in the form of the book list logo, thereby facilitating the user to read the first electronic book, and improving the efficiency of book reading and recommendation.

In each of the foregoing embodiments, at least one of the following contents is displayed in the recommendation page of the first electronic book:
book content of the first electronic book;
image data for recommending the first electronic book;
text data for recommending the first electronic book; and
multimedia content created based on the first electronic book.

In one case, the recommendation page of the first electronic book comprises the reading page of the first electronic book, and the book content of the first electronic book is displayed in the reading page, thereby facilitating the user to read the first electronic book. In another case, the image data for recommending the first electronic book, such as the promotional poster, the promotional short play, or the promotional video of the first electronic book, is displayed in the recommendation page of the first electronic book, thereby facilitating the user to get knowledge of more content about the first electronic book. In still another case, the text data for recommending the first electronic book, such as the promotional copy of the first electronic book, the content summary of the first electronic book, or the like, is displayed in the recommendation page of the first electronic book, thereby facilitating the user to decide whether it is necessary to read the first electronic book. In yet another case, the multimedia content created based on the first electronic book, such as the comic, the video, the short play, or the like created based on the first electronic book, is displayed in the recommendation page of the first electronic book, thereby assisting the user to get knowledge of peripheral information about the first electronic book.

It may be seen that according to the present embodiment, at least one of the foregoing contents may be displayed in the recommendation page of the first electronic book, thereby assisting the user to get knowledge of more content about the first electronic book, and helping the user to decide whether it is necessary to read the first electronic book.

In an embodiment, the method further comprises:
displaying interactive data for target content (e.g., first content) in response to an interactive operation performed in the second page, the target content comprising at least one selected from the group of the image in the first display area, the first published content, or the first electronic book.

Referring to FIGS. 3a and 3b, a user interaction area is also displayed in the second page, and the user may post comment information in the interaction area, and perform interaction behaviors such as giving a like and adding to favorites. The user may post the comment information related to at least one selected from the group of the image in the first display area, the first published content, or the first electronic book, may also download and save the image in the first display area, may also give a like to the content displayed in the second page, and may also add the second page to the favorites.

Based on this, the interactive data for the target content is displayed in response to the interactive operation performed by the user in the second page. The interactive operation comprises at least one selected from the group of a like operation, a comment operation, or a favorite operation. The target content comprises at least one selected from the group of the image in the first display area, the first published content, or the first electronic book, and the interactive data comprises at least one selected from the group of a like result, a favorite result, or comment information.

It may be seen that according to the present embodiment, the user may also perform interaction behaviors such as posting comment, giving a like, and adding to favorites for at least one selected from the group of the image in the first display area, the first published content, or the first electronic book in the second page, thereby improving the user experience.

Based on the content of each of the foregoing embodiments, in an example, the first post may also be selected from the posts published by the user to the reading application, and the first post satisfies at least one of the following requirements: the number of words in the first post is greater than a certain number of words, the number of likes given to the first post is greater than a certain number, the number of replies to the first post is greater than a certain number of times, the user has read the first electronic book for more than a certain period of time when publishing the first post, and the first post does not comprise specified content. In the case where the first post is a book recommendation post, the first post also needs to satisfy at least one of the following: the number of book categories recommended by the first post is less than or equal to a certain number, the proportion of books in the same category among the books recommended by the first post is greater than or equal to a certain number, and the read completion rate of at least one book in the books recommended by the first post is greater than a certain proportion, where the read completion rate refers to the proportion of the number of users who adhere to reading 100,000 words among all users who read the electronic book.

Furthermore, the first comment is selected from the comments published by the user to the reading application, and the first comment satisfies at least one of the following requirements: the number of words in the first comment is greater than a certain number of words, the number of likes given to the first comment is greater than a certain number, the number of replies to the first comment is greater than a certain number of times, the user has read the first electronic book for more than a certain period of time when publishing the first comment, and the first comment does not comprise specified content.

The first recommendation content is generated according to the selected first comment and/or the first post, and the first recommendation content is displayed in one or more information flows in the first page, where the first recommendation content is related to the first electronic book.

Furthermore, the second page is displayed in response to the trigger operation for the first recommendation content, the second page comprises the first display area and the second display area, the first display area is configured to display the image related to the first electronic book, and the second display area is configured to display at least the first published content.

Furthermore, in the case where the first recommendation content is generated based on the first comment, if the user triggers the first recommendation content, the reading page of the first electronic book may also be directly jumped to, and the first comment is displayed in the reading page, thereby facilitating the user to directly read the first electronic book and browse the first comment.

In the example, a notification message is also sent to the user, and the notification message is used to notify that the first post published by the user and/or the first comment published by the user are selected to generate the first recommendation content, and to notify the user to upload the image related to the first electronic book.

In summary, according to each of the foregoing embodiments, the first recommendation content may be displayed in the at least one column of information flow, and the image related to the first electronic book and the first published content are displayed when the first recommendation content is triggered. It may be understood that the first published content is related to the first electronic book, and since the first recommendation content is generated based on the first published content, the first recommendation content is also related to the first electronic book. Therefore, according to the embodiments, the effect of recommending the first electronic book to the user may be achieved based on the first recommendation content, the image related to the first electronic book, and the first published content, thereby improving the efficiency of recommending the electronic book to the user.

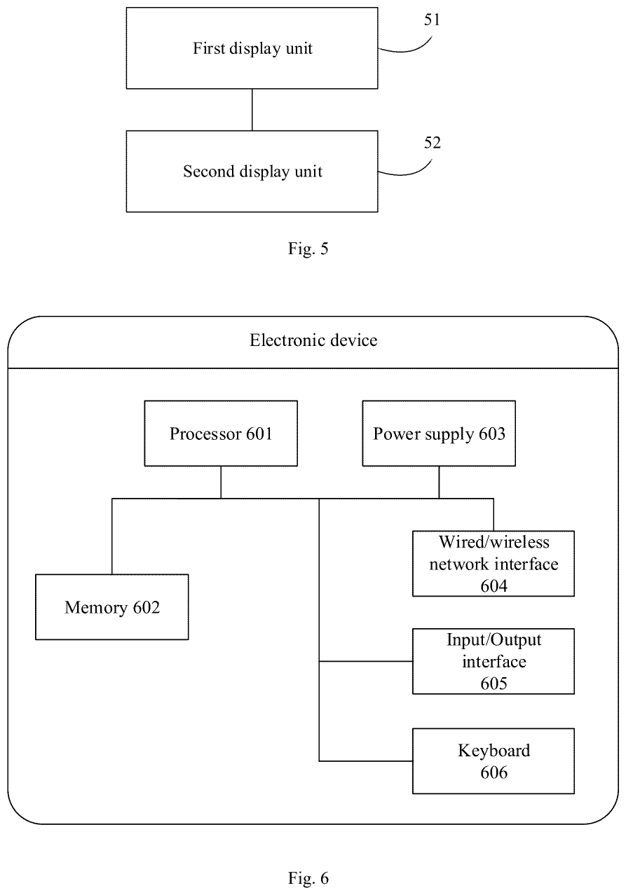

FIG. 5 is a schematic structural diagram of an information display apparatus according to an embodiment of the present disclosure. As shown in FIG. 5, the apparatus comprises a first display unit 51 and a second display unit 52.

The first display unit 51 configured to display at least one column of information flow in a first page, and display first recommendation content in the information flow, where the first recommendation content is generated based on first published content, the first published content comprises a first post belonging to a first topic and/or a first comment related to a first electronic book, and the first topic is related to the first electronic book.

The second display unit 52 configured to display a second page in response to a trigger operation for the first recommendation content, where the second page comprises a first display area and a second display area, the first display area is configured to display an image related to the first electronic book, and the second display area is configured to display at least the first published content.

Optionally, the number of the first electronic book is one, and the apparatus further comprises a first determination unit, configured to: determine hot spot information in the first electronic book, the hot spot information comprising hot spot character information and/or hot spot plot information; select the first comment from comments related to the hot spot information; and determine a topic related to the hot spot information as the first topic, and select the first post from posts belonging to the first topic.

Optionally, there are a plurality of first electronic books, a value of a probability degree at which the first electronic books are recommended synchronously is greater than a degree threshold, and the apparatus further comprises a second determination unit, configured to: determine hot spot information in the first electronic books, the hot spot information comprising hot spot character information and/or hot spot plot information; select, for each of the first electronic books, the first comment of the first electronic book from comments related to the hot spot information of the first electronic book; and determine a topic related to the first electronic books as the first topic, and select at least one first post from posts belonging to the first topic, where a content set of the first posts is used to introduce the first electronic books.

Optionally, the second display area is also configured to display first book information of the first electronic book, the first book information comprises first sub information embedded in the first published content, and/or second sub information located outside the first published content, and the apparatus further comprises a third display unit, configured to: display a recommendation page of the first electronic book in response to a trigger operation for the first book information, or in response to a trigger operation for the image in the first display area.

Optionally, the apparatus further comprises a fourth display unit, configured to: display a book list logo in the second page; display a book list in response to a trigger operation for the book list logo, second book information of the first electronic book being displayed in the book list; and display the recommendation page of the first electronic book in response to a trigger operation for the second book information.

Optionally, at least one selected from the group of the following content is displayed in the recommendation page: book content of the first electronic book; image data for recommending the first electronic book; text data for recommending the first electronic book; and multimedia content created based on the first electronic book.

Optionally, the apparatus further comprises an interaction unit, configured to display interactive data for target content in response to an interactive operation performed in the second page, the target content comprising at least one selected from the group of the image in the first display area, the first published content, or the first electronic book.

The information display apparatus in the embodiment of the present disclosure may implement each step of the foregoing information display method embodiment, and achieve the same effects and functions, which are not repeated here.

An embodiment of the present disclosure further provides an electronic device. FIG. 6 is a schematic structural diagram of an electronic device according to an embodiment of the present disclosure. As shown in FIG. 6, the electronic device may vary greatly due to different configurations or performances, and may comprise one or more processors 601 and memories 602, and one or more applications or data may be stored in the memory 602. The memory 602 may be short-term storage or persistent storage. The applications stored in the memory 602 may comprise one or more modules (not shown in the figure), and each module may comprise a series of computer-executable instructions in the electronic device. Furthermore, the processor 601 may be configured to communicate with the memory 602, and execute the series of computer-executable instructions in the memory 602 on the electronic device. The electronic device may also comprise one or more power supplies 603, one or more wired or wireless network interfaces 604, one or more input or output interfaces 605, one or more keyboards 606, and the like.

In a specific embodiment, the electronic device comprises a processor; and a memory configured to store computer-executable instructions, the computer-executable instructions, when executed, cause the processor to implement the following steps:
displaying at least one column of information flow in a first page, and displaying first recommendation content in the information flow, where the first recommendation content is generated based on first published content, the first published content comprises a first post belonging to a first topic and/or a first comment related to a first electronic book, and the first topic is related to the first electronic book; and
displaying a second page in response to a trigger operation for the first recommendation content, where the second page comprises a first display area and a second display area, the first display area is configured to display an image related to the first electronic book, and the second display area is configured to display at least the first published content.

The electronic device in the embodiment of the present disclosure may implement each step of the foregoing information display method embodiment, and achieve the same effects and functions, which are not repeated here.

Another embodiment of the present disclosure further provides a computer-readable storage medium, configured to store computer-executable instructions, the computer-executable instructions, when executed by a processor, implement the following processes:
displaying at least one column of information flow in a first page, and displaying first recommendation content in the information flow, where the first recommendation content is generated based on first published content, the first published content comprises a first post belonging to a first topic and/or a first comment related to a first electronic book, and the first topic is related to the first electronic book; and
displaying a second page in response to a trigger operation for the first recommendation content, where the second page comprises a first display area and a second display area, the first display area is configured to display an image related to the first electronic book, and the second display area is configured to display at least the first published content.

The computer-readable storage medium in the embodiment of the present disclosure may implement each step of the foregoing information display method embodiment, and achieve the same effects and functions, which are not repeated here.

Another embodiment of the present disclosure further provides a computer program product, comprising a computer program, the computer program, when executed by a processor, implements the following processes:
displaying at least one column of information flow in a first page, and displaying first recommendation content in the information flow, where the first recommendation content is generated based on first published content, the first published content comprises a first post belonging to a first topic and/or a first comment related to a first electronic book, and the first topic is related to the first electronic book; and
displaying a second page in response to a trigger operation for the first recommendation content, where the second page comprises a first display area and a second display area, the first display area is configured to display an image related to the first electronic book, and the second display area is configured to display at least the first published content.

The computer program product in the embodiment of the present disclosure may implement each step of the foregoing information display method embodiment, and achieve the same effects and functions, which are not repeated here.

In each of the embodiments of the present disclosure, the computer-readable storage medium comprises a read-only memory (ROM), a random access memory (RAM), a magnetic disk, an optical disk, or the like.

In the 1990s, an improvement to a technology may be clearly distinguished as a hardware improvement (for example, an improvement to a circuit structure, such as a diode, a transistor, or a switch) or a software improvement (an improvement to a method flow). However, with the development of technologies, many improvements to modern method flows may be regarded as direct improvements to hardware circuit structures. Designers almost always obtain the corresponding hardware circuit structure by programming the improved method flow into a hardware circuit. Therefore, it cannot be said that an improvement to a method flow cannot be implemented with a hardware entity module. For example, a programmable logic device (PLD) (such as a field programmable gate array (Field Programmable Gate Array, FPGA)) is such an integrated circuit whose logic function is determined by a user by programming the device. Instead of asking a chip manufacturer to design and fabricate a dedicated integrated circuit chip, a designer may program by himself to “integrate” a digital system on a PLD. Furthermore, today, instead of manually fabricating an integrated circuit chip, this programming is mostly implemented using “logic compiler” software, which is similar to the software compiler used in program development and writing, and the original code before compilation also has to be written in a specific programming language, which is referred to as a hardware description language (HDL). There is not only one type of HDL, but many types, such as ABEL (Advanced Boolean Expression Language), AHDL (Altera Hardware Description Language), Confluence, CUPL (Cornell University Programming Language), HDCal, JHDL (Java Hardware Description Language), Lava, Lola, MyHDL, PALASM, RHDL (Ruby Hardware Description Language), etc. Currently, the most commonly used are VHDL (Very-High-Speed Integrated Circuit Hardware Description Language) and Verilog. Persons skilled in the art should also be clear that the hardware circuit that implements the logic method flow may be easily obtained just by slightly logically programming the method flow in the foregoing several hardware description languages and programming it into an integrated circuit.

The controller may be implemented in any suitable manner, for example, the controller may take the form of a microprocessor or processor and a computer-readable medium that stores computer-readable program code (such as software or firmware) executable by the (micro)processor, a logic gate, a switch, an application specific integrated circuit (Application Specific Integrated Circuit, ASIC), a programmable logic controller, and an embedded microcontroller. Examples of the controller comprise, but are not limited to, the following microcontrollers: ARC 625D, Atmel AT91SAM, Microchip PIC18F26K20, and Silicone Labs C8051F320. The memory controller may also be implemented as part of the control logic of the memory. Persons skilled in the art also know that in addition to implementing the controller in a pure computer-readable program code manner, it is entirely possible to logically program method steps to enable the controller to implement the same functions in the form of a logic gate, a switch, an application specific integrated circuit, a programmable logic controller, and an embedded microcontroller. Therefore, such a controller may be regarded as a hardware component, and the apparatus comprised therein for implementing various functions may also be regarded as a structure within the hardware component. Or even, the apparatus for implementing various functions may be regarded as both a software module for implementing the method and a structure within the hardware component.

The systems, apparatuses, modules, or units set forth in the foregoing embodiments may be implemented specifically by a computer chip or entity, or by a product having a certain function. A typical implementation device is a computer. Specifically, the computer may be, for example, a personal computer, a laptop computer, a cellular phone, a camera phone, a smart phone, a personal digital assistant, a media player, a navigation device, an email device, a game console, a tablet computer, a wearable device, or a combination of any of these devices.

For ease of description, when described, the foregoing apparatus is divided into various units based on functions. Certainly, when the embodiments of the present disclosure are implemented, the functions of the units may be implemented in the same software and/or hardware or in multiple pieces of software and/or hardware.

Persons skilled in the art should understand that one or more embodiments of the present disclosure may be provided as a method, a system, or a computer program product. Therefore, one or more embodiments of the present disclosure may take the form of an entirely hardware embodiment, an entirely software embodiment, or an embodiment containing both hardware and software elements. Furthermore, one or more embodiments of the present disclosure may take the form of a computer program product implemented on one or more computer-usable storage media (comprising, but not limited to, a disk memory, a CD-ROM, an optical memory, etc.) having computer-usable program code embodied therein.

The present disclosure is described with reference to flowcharts and/or block diagrams of methods, devices (systems), and computer program products according to embodiments of the present disclosure. It should be understood that each process and/or block in the flowchart and/or block diagram, and a combination of the processes and/or blocks in the flowchart and/or block diagram may be implemented by computer program instructions. These computer program instructions may be provided to a processor of a general-purpose computer, a special-purpose computer, an embedded processor, or another programmable data processing device to generate a machine, so that the instructions executed by the processor of the computer or another programmable data processing device generate an apparatus for implementing a function specified in one or more processes in the flowchart and/or in one or more blocks in the block diagram.

These computer program instructions may also be stored in a computer-readable memory that may direct the computer or another programmable data processing device to work in a specific manner, so that the instructions stored in the computer-readable memory generate a manufactured product comprising an instruction apparatus that implements the function specified in one or more processes in the flowchart and/or in one or more blocks in the block diagram.

These computer program instructions may also be loaded onto the computer or another programmable data processing device, so that a series of operations and steps are performed on the computer or another programmable device to generate computer-implemented processing, and the instructions executed on the computer or another programmable device provide steps for implementing the function specified in one or more processes in the flowchart and/or in one or more blocks in the block diagram.

It also needs to be noted that the terms “include”, “comprise”, or any other variation thereof are intended to cover non-exclusive inclusion, so that a process, method, product, or device that comprises a series of elements comprises not only those elements, but also other elements not explicitly listed or elements inherent to such process, method, product, or device. Without further restrictions, an element defined by the phrase “comprises a” does not exclude the existence of other identical elements in the process, method, product, or device that comprises the element.

One or more embodiments of the present disclosure may be described in the general context of computer-executable instructions, such as program modules, executed by a computer. Generally, the program modules comprise routines, programs, objects, components, data structures, etc., that perform specific tasks or implement specific abstract data types. One or more embodiments of the present disclosure may also be practiced in distributed computing environments, in which tasks are performed by remote processing devices connected through a communication network. In the distributed computing environment, the program modules may be located in local and remote computer storage media comprising storage devices.

The embodiments of the present disclosure are described in a progressive manner, and the same or similar parts between the embodiments may be referred to each other, and each embodiment focuses on the differences from other embodiments. In particular, the system embodiment is relatively briefly described because it is basically similar to the method embodiment, and reference may be made to the description of the method embodiment for the relevant parts.

The foregoing descriptions are merely embodiments of the present disclosure and are not intended to limit the present disclosure. For persons skilled in the art, the present disclosure may have various modifications and changes. Any modification, equivalent replacement, improvement, etc. made within the spirit and principle of the present disclosure shall fall within the scope of the claims of the present disclosure.

1. A method for information display, comprising:
displaying at least one column of information flow in a first page, and displaying first recommendation content in the information flow, wherein the first recommendation content is generated based on first published content, the first published content comprises a first post belonging to at least one selected from a group of a first topic or a first comment related to a first electronic book, and the first topic is related to the first electronic book; and
displaying a second page in response to a trigger operation for the first recommendation content, wherein the second page comprises a first display area and a second display area, the first display area is configured to display an image related to the first electronic book, and the second display area is configured to display at least the first published content.

2. The method of claim 1, wherein there is one first electronic book; and the method further comprises:
determining hot spot information in the first electronic book, wherein the hot spot information comprises at least one selected from a group of hot spot character information or hot spot plot information;
selecting the first comment from comments related to the hot spot information; and
determining a topic related to the hot spot information as the first topic, and selecting the first post from posts belonging to the first topic.

3. The method of claim 1, wherein there are a plurality of first electronic books, and a value of a probability degree at which the first electronic books are synchronously recommended is greater than a degree threshold; and the method further comprises:
determining hot spot information in the first electronic books, wherein the hot spot information comprises at least one selected from a group of hot spot character information or hot spot plot information;
for a first electrode book of the first electronic books, selecting the first comment of the first electronic book from comments related to the hot spot information of the first electronic book; and
determining a topic related to the first electronic book as the first topic, and selecting at least one first post from posts belonging to the first topic, wherein a content set of the at least one first post is used to introduce the first electronic book.

4. The method of claim 1, wherein the second display area is further configured to display first book information of the first electronic book, wherein the first book information comprises at least one selected from a group of first sub information embedded in the first published content, or second sub information located outside the first published content; and the method further comprises:
displaying a recommendation page of the first electronic book in response to a trigger operation for the first book information, or in response to a trigger operation for the image in the first display area.

5. The method of claim 4, wherein at least one of following contents is displayed in the recommendation page:
book content of the first electronic book;
image data for recommending the first electronic book;
text data for recommending the first electronic book; and
multimedia content created based on the first electronic book.

6. The method of claim 1, further comprising:
displaying a book list logo in the second page;
displaying a book list in response to a trigger operation for the book list logo, wherein second book information of the first electronic book is displayed in the book list; and
displaying a recommendation page of the first electronic book in response to a trigger operation for the second book information.

7. The method of claim 6, wherein at least one of following contents is displayed in the recommendation page:
book content of the first electronic book;
image data for recommending the first electronic book;
text data for recommending the first electronic book; and
multimedia content created based on the first electronic book.

8. The method of claim 1, further comprising:
displaying interactive data for first content in response to an interactive operation performed in the second page, wherein the first content comprises at least one selected from a group of the image in the first display area, the first published content, or the first electronic book.

9. An electronic device, comprising:
at least a processor; and
a memory configured to store computer-executable instructions, wherein the computer-executable instructions, when executed, cause the processor to implement an information display method, which comprises:
displaying at least one column of information flow in a first page, and displaying first recommendation content in the information flow, wherein the first recommendation content is generated based on first published content, the first published content comprises a first post belonging to at least one selected from a group of a first topic or a first comment related to a first electronic book, and the first topic is related to the first electronic book; and
displaying a second page in response to a trigger operation for the first recommendation content, wherein the second page comprises a first display area and a second display area, the first display area is configured to display an image related to the first electronic book, and the second display area is configured to display at least the first published content.

10. The electronic device of claim 9, wherein there is one first electronic book; and the method further comprises:
determining hot spot information in the first electronic book, wherein the hot spot information comprises at least one selected from a group of hot spot character information or hot spot plot information;
selecting the first comment from comments related to the hot spot information; and
determining a topic related to the hot spot information as the first topic, and selecting the first post from posts belonging to the first topic.

11. The electronic device of claim 9, wherein there are a plurality of first electronic books, and a value of a probability degree at which the first electronic books are synchronously recommended is greater than a degree threshold; and the method further comprises:
determining hot spot information in the first electronic books, wherein the hot spot information comprises at least one selected from a group of hot spot character information or hot spot plot information;
for a first electrode book of the first electronic books, selecting the first comment of the first electronic book from comments related to the hot spot information of the first electronic book; and
determining a topic related to the first electronic book as the first topic, and selecting at least one first post from posts belonging to the first topic, wherein a content set of the at least one first post is used to introduce the first electronic book.

12. The electronic device of claim 9, wherein the second display area is further configured to display first book information of the first electronic book, wherein the first book information comprises at least one selected from a group of first sub information embedded in the first published content, or second sub information located outside the first published content; and the method further comprises:
displaying a recommendation page of the first electronic book in response to a trigger operation for the first book information, or in response to a trigger operation for the image in the first display area.

13. The electronic device of claim 12, wherein at least one of following contents is displayed in the recommendation page:
book content of the first electronic book;
image data for recommending the first electronic book;
text data for recommending the first electronic book; and
multimedia content created based on the first electronic book.

14. The electronic device of claim 9, further comprising:
displaying a book list logo in the second page;
displaying a book list in response to a trigger operation for the book list logo, wherein second book information of the first electronic book is displayed in the book list; and
displaying a recommendation page of the first electronic book in response to a trigger operation for the second book information.

15. The electronic device of claim 14, wherein at least one of following contents is displayed in the recommendation page:
book content of the first electronic book;
image data for recommending the first electronic book;
text data for recommending the first electronic book; and
multimedia content created based on the first electronic book.

16. The electronic device of claim 9, further comprising:
displaying interactive data for first content in response to an interactive operation performed in the second page, wherein the first content comprises at least one selected from a group of the image in the first display area, the first published content, or the first electronic book.

17. A non-transitory computer-readable storage medium, configured to store computer-executable instructions, wherein the computer-executable instructions, when executed by at least a processor, implement an information display method, which comprises:
displaying at least one column of information flow in a first page, and displaying first recommendation content in the information flow, wherein the first recommendation content is generated based on first published content, the first published content comprises a first post belonging to at least one selected from a group of a first topic or a first comment related to a first electronic book, and the first topic is related to the first electronic book; and
displaying a second page in response to a trigger operation for the first recommendation content, wherein the second page comprises a first display area and a second display area, the first display area is configured to display an image related to the first electronic book, and the second display area is configured to display at least the first published content.

18. The storage medium of claim 17, wherein there is one first electronic book; and the method further comprises:
determining hot spot information in the first electronic book, wherein the hot spot information comprises at least one selected from a group of hot spot character information or hot spot plot information;
selecting the first comment from comments related to the hot spot information; and
determining a topic related to the hot spot information as the first topic, and selecting the first post from posts belonging to the first topic.

19. The storage medium of claim 17, wherein there are a plurality of first electronic books, and a value of a probability degree at which the first electronic books are synchronously recommended is greater than a degree threshold; and the method further comprises:
determining hot spot information in the first electronic books, wherein the hot spot information comprises at least one selected from a group of hot spot character information or hot spot plot information;
for a first electrode book of the first electronic books, selecting the first comment of the first electronic book from comments related to the hot spot information of the first electronic book; and
determining a topic related to the first electronic book as the first topic, and selecting at least one first post from posts belonging to the first topic, wherein a content set of the at least one first post is used to introduce the first electronic book.

20. The storage medium of claim 17, wherein the second display area is further configured to display first book information of the first electronic book, wherein the first book information comprises at least one selected from a group of first sub information embedded in the first published content, or second sub information located outside the first published content; and the method further comprises:
displaying a recommendation page of the first electronic book in response to a trigger operation for the first book information, or in response to a trigger operation for the image in the first display area.
